(19) United States
(12) Patent Application Publication
(10) Pub. No.: US 2023/0185146 A1
(43) Pub. Date: Jun. 15, 2023

(54) PRIVACY FILM AND DISPLAY DEVICE

(71) Applicant: WUHAN CHINA STAR OPTOELECTRONICS TECHNOLOGY CO., LTD., Wuhan, Hubei (CN)

(72) Inventors: Xindong MEI, Wuhan, Hubei (CN); Rui HE, Wuhan, Hubei (CN); Wei CHENG, Wuhan, Hubei (CN); Wenlong YE, Wuhan, Hubei (CN)

(21) Appl. No.: 17/623,900

(22) PCT Filed: Dec. 20, 2021
(86) PCT No.: PCT/CN2021/139790

§ 371 Date: Dec. 30, 2021

(30) Foreign Application Priority Data
Dec. 13, 2021 (CN) 202111522142.0

(51) Int. Cl. G02F 1/137; G02F 1/1335; G02F 1/1334; G02F 1/1337

(52) U.S. Cl. CPC G02F 1/137; G02F 1/133531; G02F 1/13345; G02F 1/1337; G02F 2203/48; G02F 2202/28; G02F 2203/01

(57) ABSTRACT

A privacy film and a display device are provided. The privacy film comprises a liquid crystal dimming cell and a first polarizer. The liquid crystal dimming cell comprises two opposed substrates and a liquid crystal layer sandwiched between the two substrates. The liquid crystal layer comprises a plurality of liquid crystal molecules, and the plurality of liquid crystal molecules have the same fixed orientation angle, and an orthogonal projection of long axes of the liquid crystal molecules on the first substrate is perpendicular to an absorption axis of the first polarizer. As such, the brightness of the display screen will not be affected when looking up from the front, and the privacy-image protection effect for decreasing the brightness of the display screen when looking up from the side is achieved.

### FIELD OF INVENTION

The present disclosure relates to the field of display technology, in particular to a privacy film and a display device.

### BACKGROUND OF DISCLOSURE

Current display products have been widely used in personal display devices. With the rapid development of the information age, people are paying more and more attention to the protection of personal information, and the demand for display devices with anti-peeping functions will become more and more common.

At present, the main privacy film is mainly based on the principle of louver structure. Although this kind of privacy film can realize privacy protection, it has a great attenuation of the brightness of the display device, and has major drawbacks.

### SUMMARY OF INVENTION

### Technical Problem

The embodiments of the present disclosure provide a privacy film and a display device to solve the technical problem that the existing privacy film greatly attenuates the brightness of the display device and affects the display brightness.

### Technical Solutions

To solve the above problems, the technical solutions provided by this application are as follows:

An embodiment of the present disclosure provides a display panel, comprising a first substrate, a second substrate, and a liquid crystal layer disposed between the first substrate and the second substrate arranged in a cell,

An embodiment of the present disclosure provides a privacy film, comprising:

a liquid crystal dimming cell comprising a first substrate and a second substrate that are opposed to each other, and a liquid crystal layer sandwiched between the first substrate and the second substrate, wherein the liquid crystal layer comprises a liquid crystal composition, and the liquid crystal composition comprises a plurality of liquid crystal molecules; and

a first polarizer disposed on one side of the liquid crystal dimming cell;

wherein all of the plurality of liquid crystal molecules have the same fixed orientation angle with respect to the first substrate, and an orthogonal projection of long axes of the liquid crystal molecules on the first substrate is perpendicular to an absorption axis of the first polarizer.

In some embodiments of the present disclosure, the fixed orientation angle of the liquid crystal molecules with respect to the first substrate is 30°-89°.

In some embodiments of the present disclosure, the fixed orientation angle of the liquid crystal molecules with respect to the first substrate is 30°^{˜}70°.

In some embodiments of the present disclosure, the long axes of the plurality of liquid crystal molecules are arranged obliquely along the same direction, or are distributed symmetrically with respect to the normal direction of the first substrate.

In some embodiments of the present disclosure, the privacy film satisfies the following condition:

Δn×d=cos θ×(λ/2+N×λ), where Δn is a difference in birefringence of the liquid crystal molecule, d is a thickness of the liquid crystal layer, θ is an angle formed by an oblique line deviating from the normal direction of the liquid crystal dimming cell and the normal direction of the liquid crystal dimming cell, 0<θ<90°, λ is a wavelength of visible light in vacuum, and N is zero or a positive integer greater than zero.

In some embodiments of the present disclosure, the liquid crystal composition further comprises a polymer, and the polymer accounts for 20% to 70% of a mass percentage of the liquid crystal composition.

In some embodiments of the present disclosure, the liquid crystal composition comprises a polymer network and the liquid crystal molecules, and the long axes of the polymer network and the liquid crystal molecules are aligned in the same direction.

An embodiment of the present disclosure further provides a display device, including a display panel and a privacy film disposed on one side of the display panel, wherein the privacy film is the privacy film described in any of the foregoing embodiments.

In some embodiments of the present disclosure, the display panel comprises a display panel body and a second polarizer disposed on one side of the display panel body, and the liquid crystal layer of the privacy film is located between the second polarizer and the first polarizer of the privacy film, and an absorption axis direction of the first polarizer is parallel to an absorption axis direction of the second polarizer.

In some embodiments of the present disclosure, the privacy film is disposed on one side of a light emitting surface of the display panel body, and the second polarizer is disposed on one side of the light emitting surface of the display panel body.

In some embodiments of the present disclosure, the privacy film is disposed on one side facing away from the light emitting surface of the display panel body, and the second polarizer is disposed on one side facing away from the light emitting surface of the display panel body.

In some embodiments of the present disclosure, the display panel further comprises a third polarizer and a backlight module, the third polarizer is disposed on one side of the light emitting surface of the display panel body, and the first polarizer is disposed between the light emitting surface of the backlight module and the liquid crystal layer.

In some embodiments of the present disclosure, a first alignment film is disposed on one side of the first substrate facing the liquid crystal layer, and a second alignment film is disposed on one side of the second substrate facing the liquid crystal layer.

In some embodiments of the present disclosure, the privacy film and the display panel are adhered by an adhesive layer.

### Benefit Effects

The embodiment of the present disclosure provides a privacy film and a display device. The privacy film comprises a liquid crystal dimming cell, a first polarizer disposed on one side of the liquid crystal dimming cell. The liquid crystal dimming cell comprises a first substrate and a second substrate that are opposed to each other, and a liquid crystal layer sandwiched between the first substrate and the second substrate. The liquid crystal layer comprises a liquid crystal composition, and the liquid crystal composition comprises a plurality of liquid crystal molecules; wherein, the a plurality of liquid crystal molecules have the same fixed orientation angle with respect to the first substrate, and an orthogonal projection of long axes of the liquid crystal molecules on the first substrate is perpendicular to an absorption axis of the first polarizer, realizing front view The brightness of the display screen will not be affected when the camera is viewed, and the brightness of the display screen will be reduced when the camera is squinted, achieving a visual anti-peeping effect. As such, the brightness of the display screen will not be affected when looking up from the front, and the visual anti-peeping effect for decreasing the brightness of the display screen when looking out from the side is achieved.

### BRIEF DESCRIPTION OF DRAWINGS

FIG. 1 is a schematic structural diagram of a privacy film provided by an embodiment of the present disclosure.

FIG. 2 is a schematic structural diagram of a privacy film provided by another embodiment of the present disclosure.

FIG. 3 is a schematic diagram of polarized light propagating in the privacy film provided by an embodiment of the present disclosure.

FIG. 4 is a schematic structural diagram of a display device provided by an embodiment of the present disclosure.

FIG. 5 is a schematic structural diagram of a display device provided by other embodiments of the present disclosure.

### DETAILED DESCRIPTION OF PREFERRED EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, rather than all the embodiments. Based on the embodiments in the present disclosure, all other embodiments obtained by those skilled in the art without creative work shall fall within the protection scope of present disclosure.

In the description of the present disclosure, it should be understood that terms “first” and “second” are used herein for purposes of description and are not intended to indicate or imply relative importance or implicitly indicate the number of the indicated technical features. Therefore, the features limited by “first” and “second” are intended to indicate or imply including one or more than one these features. In the description of the present disclosure, “a plurality of” relates to two or more than two, unless otherwise specified.

The following disclosure provides many different embodiments or examples for realizing different structures of the present disclosure. In order to simplify the disclosure of the present disclosure, the components and arrangements of specific examples are described below. Of course, they are only examples, and are not intended to limit the present disclosure. In addition, the present disclosure may repeat reference numerals and/or reference letters in different examples. Such repetition is for the purpose of simplification and clarity, and does not indicate the relationship between the various embodiments and/or arrangements discussed. In addition, the present disclosure provides examples of various specific processes and materials, but those of ordinary skill in the art may be aware of the present disclosure of other processes and/or the use of other materials.

Please refer to FIG. 1. An embodiment of the present disclosure provides a privacy film 10, the privacy film 10 comprises a liquid crystal dimming cell 11 and a first polarizer 12, the first polarizer 12 is disposed on one side of the liquid crystal dimming cell 11. The liquid crystal dimming cell 11 comprises a first substrate 111 and a second substrate 113 disposed opposite to each other, and a liquid crystal layer 112 sandwiched between the first substrate 111 and the second substrate 113, and the liquid crystal layer 112 comprises a liquid crystal composition, and the liquid crystal composition comprises liquid crystal molecules. In addition, the plurality of liquid crystal molecules have the same fixed orientation angle a with respect to the first substrate 111, and an orthogonal projection of long axes of the liquid crystal molecules on the first substrate 111 is perpendicular to an absorption axis of first polarizer 12.

The first polarizer 12 is disposed on one side of the liquid crystal dimming cell 11, which means that the first polarizer 12 is disposed on the outside or inside of the liquid crystal dimming cell 11. In particular, the first polarizer 12 may be disposed on an inner side of the first substrate 111 of the liquid crystal dimming cell 11, or an outer side of the first substrate 111, or an inner side of the second substrate 113 of the liquid crystal dimming cell 11, or an outer side of the second substrate 113. In addition, the inner side of the first substrate 111 mentioned in embodiments of the present disclosure refers to one side of the first substrate 111 close to the liquid crystal layer 112, and the inner side of the second substrate 113 refers to one side of the second substrate 113 close to the liquid crystal layer 112. It can be understood that the outer side of the first substrate 111 refers to one side of the first substrate 111 facing away from the liquid crystal layer 112, and the outer side of the second substrate 113 refers to one side facing away from one side of the first substrate 111 facing away from the liquid crystal layer 112.

The fixed orientation angle mentioned in embodiments of the present disclosure means that the orientation angle of the liquid crystal after the alignment is fixed, and the liquid crystal will no longer be deflected under the force of an electric field or the like.

In an embodiment of the present disclosure, the liquid crystal combination group may be a polymer dispersed liquid crystal or a polymer network liquid crystal. The liquid crystal composition comprises a polymer and a liquid crystal, and the polymer accounts for 20% to 70% by a mass percentage of the liquid crystal composition. In particular, the polymer is formed by polymerizing monomers under certain conditions. Before being cured (that is, before forming a polymer dispersed liquid crystal or a polymer network liquid crystal), the liquid crystal composition comprises the above-mentioned polymer monomer, photoinitiator, and liquid crystal material. Among them, the polymer monomer is polymerized to form a polymer under the irradiation of the photoinitiator and ultraviolet light. The polymer monomer accounts for 20% to 70% of a mass percentage of the liquid crystal composition, therefore the polymer content of the embodiment of the present disclosure is significantly increased in comparation with the polymer content of the liquid crystal composition in the prior art. Thereby, the curing degree of the formed polymer dispersed liquid crystal or polymer network liquid crystal structure can be improved, such that the liquid crystal layer 112 has a fixed orientation angle after orientation, and therefore the privacy film provided by the embodiment of the present disclosure is a fixed privacy film. The orientation angle of the molecules will not be affected by the electric field and the like, that is, the liquid crystal molecules will not be deflected. Optionally, the mass percentage of the polymer in the liquid crystal composition is 30%-40%.

Polymer network liquid crystal is taken as an example in an embodiment of the present disclosure. The liquid crystal mixture prepared by polymer monomer, photoinitiator, liquid crystal and other materials is exposed to ultraviolet light under the control of alignment film or electric field, and photopolymerization of polymer monomers occurs to form a polymer network structure with a certain tilt angle and regular orientation. The liquid crystal molecules are regularly aligned along the tilt angle under the effect of the anchoring force of the polymer network, and finally a polymer network liquid crystal structure with a specific tilt angle and regular orientation is formed.

In an embodiment of the present disclosure, the specific tilt angle may be 30°-89°, that is, the fixed orientation angle a of the liquid crystal molecules with respect to the first substrate 111 is 30°-89°. Optionally, the fixed orientation angle a is 30°-70°.

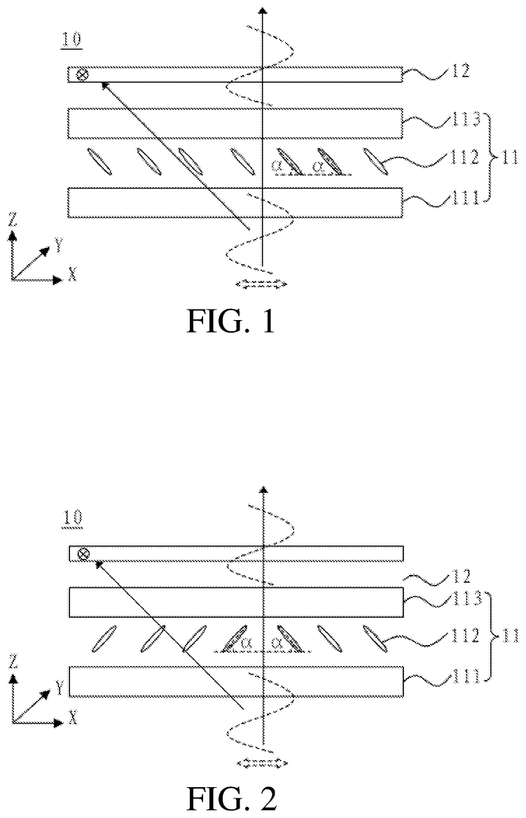

As shown in FIGS. 1 and 2, the long axes of the plurality of liquid crystal molecules may be arranged obliquely along the same direction, or may be symmetrically distributed with respect to a normal direction of the first substrate 111, and only need to satisfy the requirements that an orthogonal projection of long axes of the plurality of liquid crystal molecules on the first substrate 111 are arranged in the same direction. The orthogonal projection of the long axes of the molecule on the first substrate 111 may be arranged in the same direction. The long axes of all liquid crystal molecules arranged obliquely along the same direction are taken as an example in an embodiment of the present disclosure.

The inner side of the first substrate 111 (the side facing the liquid crystal layer 112) may be provided with a first alignment film, and the inner side of the second substrate 113 (the side facing the liquid crystal layer 112) may be provided with a second alignment film. Said liquid crystal mixture is affected by the first alignment film and the second alignment film and are cured by ultraviolet light to form a polymer network liquid crystal with a fixed orientation angle. In other embodiments, other methods such as embossing can also be used to align the liquid crystal of the liquid crystal layer 112.

In addition, in the polymer network liquid crystal, an alignment direction of the long axes of the polymer network and the liquid crystal molecules (the direction in which the fixed orientation angle is located) is the same. Therefore, there will be no difference in refractive index between the polymer network and the liquid crystal molecules, and light will not be scattered when passing through the polymer network liquid crystal.

For the convenience of description, the orthogonal projection of the long axes of the liquid crystal molecules on the first substrate 111 is the first direction X, the absorption axis direction of the first polarizer 12 is the second direction Y, and the normal direction of the first substrate 111 is the third direction Z, wherein the first direction X, the second direction Y, and the third direction Y are perpendicular to each other.

As shown in FIG. 1, a polarization direction of an incident light at a front viewing angle is along the first direction X, and its propagation direction is along the third direction Z. A vibration plane of the incident light is parallel to the long axes of the liquid crystal molecules, such that an angle between the vibration plane of the incident light at the front viewing angle and the long axis of the liquid crystal molecule is 0°. When the incident light in this direction passes through the liquid crystal layer 112, it only passes through the short axis of the liquid crystal molecule, such that there is no phase difference. After the light passes through the liquid crystal layer 112, its polarization state does not change, and its polarization direction is perpendicular to the absorption axis of the first polarizer 12, such that incident light with a front viewing angle can pass through the first polarizer 12 to reach Human eye.

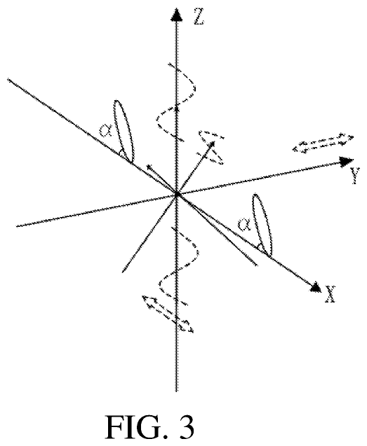

As shown in FIG. 3, a polarization direction of an incident light at an oblique viewing angle is along the first direction X, and a propagation direction forms an angle with the third direction Z. Therefore, there is an angle between a vibration plane of the incident light at the oblique viewing angle and the liquid crystal molecules. When the incident light with an oblique viewing angle passes through the liquid crystal layer 112, it will pass through the long axes and the short axes of the liquid crystal molecules at the same time, resulting in a phase difference, such that the polarization state of the incident light with the oblique viewing angle after passing through the liquid crystal layer 112 is changed. After changed, the polarization direction is no longer perpendicular to the absorption axis of the first polarizer 12, such that the incident light with the oblique viewing angle will be partially or completely absorbed by the first polarizer 12.

In some embodiments of the present disclosure, a thickness d of the liquid crystal layer 112 can be designed such that the thickness of the liquid crystal layer 112 satisfies the following formula: Δn×d=cos θ×(λ/2+N×λ), where Δn is a difference in the birefringence of the liquid crystal molecules, d is a thickness of the liquid crystal layer 112, θ is an angle formed by the direction of the oblique viewing angle of the human eye and a normal direction of the liquid crystal dimming cell, that is, θ is an angle formed by the oblique line deviating from the normal direction of the liquid crystal dimming cell and the normal direction of the liquid crystal dimming cell, 0<0<90°, and λ is a wavelength of visible light in vacuum. In this way, the liquid crystal layer 112 is equivalent to a half glass slide. When the angle between the vibration plane of the incident polarized light and the long axis of the liquid crystal is β, the vibration direction of the incident polarized light is rotated by 2β after passing through the liquid crystal layer 112.

In particular, the fixed orientation angle a of the liquid crystal molecules can be adjusted such that the angle β between the vibration plane of the incident polarized light in the oblique direction of 45° and the long axes of the liquid crystal is 45°. Therefore, when looking up from the side at the angle of 45°, the polarization direction of the polarized light is rotated by 90 after the polarized light passes through the liquid crystal layer 112, and the polarization direction of the polarized light after passing through the liquid crystal layer 112 is parallel to the first polarizer 12, the light is completely absorbed, and the best anti-peep effect of 45° angle oblique viewing is achieved.

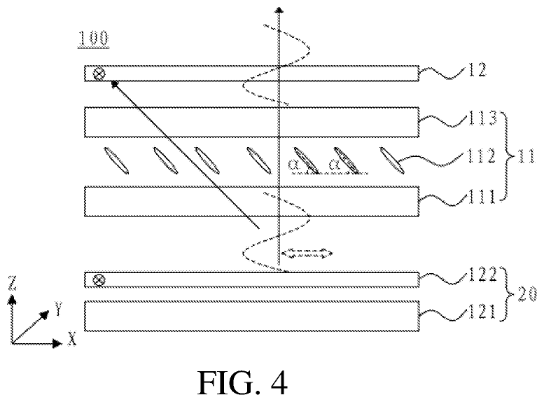

Therefore, the privacy film provided by the embodiments of the present disclosure can be applied in a display device, such that the display device has a privacy protection function. As shown in FIG. 4, the display device comprises a privacy film 10 of the above-mentioned embodiment, and a display panel 20 disposed on one side of the privacy film 10. The display panel 20 comprises a display panel body 121 and a second polarizer 122 disposed on one side of the display panel body 121, wherein the liquid crystal dimming cell 11 is located between the first polarizer 12 and the second polarizer 12, and an absorption axis direction of the first polarizer 12 is parallel to an absorption axis direction of the second polarizer 122.

As shown in FIG. 4, in some embodiments of the present disclosure, the privacy film 10 may be disposed on one side of a light emitting surface of a display panel body 121. The privacy film 10 and the display panel 20 can be adhered by an adhesive layer, and the adhesive layer comprises but not limited to OCA (Optically Clear Adhesive) adhesive layer, OCR (Optical Clear Resin) glue layer, and the like. The privacy film 10 can also be directly placed on the display panel 20.

When the privacy film 10 is disposed on one side of the light emitting surface of the display panel body 121, the second polarizer 122 may be disposed on one side of the light emitting surface of the display panel body 121, and the first polarizer 12 is disposed on one side of the liquid crystal dimming cell 11 away from the display panel 20. The polarized light with a front viewing angle emitted by the second polarizer 122 of the display panel 20 will not produce a phase difference after passing through the liquid crystal layer 112, and its polarization direction will not change. In addition, the absorption axis of the second polarizer 122 and the absorption axis of the first polarizer 12 are parallel to each other, such that the polarized light after passing through the liquid crystal layer 11 can be directly emitted from the first polarizer 12, and the emitted light is not lost and does not affect the display effect when looking up from the front.

After passing through the liquid crystal layer 112, the polarized light with an oblique viewing angle emitted from the second polarizer 122 of the display panel 20 will have a phase difference, and its polarization direction will change. In addition, the absorption axis of the second polarizer 122 and the absorption axis of the first polarizer 12 are parallel to each other, therefore the polarization direction of the polarized light after passing through the liquid crystal layer 112 is no longer perpendicular to the absorption axis of the first polarizer 12, and the light will be partially or completely absorbed by the first polarizer 12, thereby in the oblique direction, it will show a dark state display and an anti-peeping effect is achieved.

Furthermore, when the liquid crystal layer 112 satisfies Δn×d=λ/2, when the human eye looks obliquely at 45° along the YZ plane (the plane formed by the first direction X and the third direction Z), the light passes through the liquid crystal layer 112, i.e. passing through a half glass slide, and its polarization direction will be rotated by 90°, and the light traveling along 45° will be completely absorbed by the first polarizer 12. The anti-peep effect of other oblique viewing angles is between the effect of the front viewing angle and the effect of 45° oblique viewing effect.

The display panel body 121 may be an OLED display panel body, and the display panel body 121 comprises an array substrate having a pixel driving circuit and a light emitting unit disposed on the array substrate. The display panel body 121 may also be a liquid crystal display panel body, the display panel 20 may further comprise a third polarizer, the display device 100 may further comprise a backlight module (not shown in FIG. 4), the third polarizer is disposed on one side of the light emitting surface away from the display panel body 121, an absorption axis of the third polarizer is perpendicular to the absorption axis of the second polarizer, and the backlight module is disposed on one side of the third polarizer away from the display panel body 121, wherein the backlight module may be a direct-type backlight module.

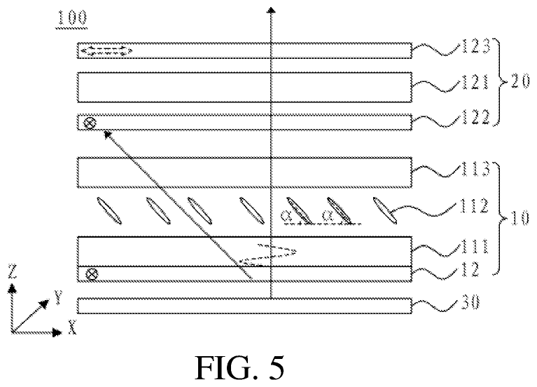

In other embodiments, referring to FIG. 5, the privacy film 10 may be disposed on one side of the light emitting surface away from the display panel body 121, and the second polarizer 122 may be disposed on one side of the light emitting surface away from the display panel body 121.

In particular, the third polarizer 123 is disposed on one side of the light emitting surface of the display panel body 121, and the first polarizer 12 is disposed on one side of the liquid crystal layer 112 away from the display panel 20, and the backlight module 30 is disposed on one side of the first polarizer 12 away from the liquid crystal layer 112, that is, the first polarizer 12 is disposed between the light emitting surface of the backlight module 30 and the liquid crystal layer 112.

After the visible light emitted by the backlight module 30 passes through the first polarizer 12, the light becomes the polarized light. After the polarized light with a front viewing angle passes through the liquid crystal layer 112, its polarization direction will not change and the polarized light can pass through the second polarized light. The film 122 directly enters the display panel 20, and its light will not be lost; after the polarized light with an oblique viewing angle passes through the liquid crystal layer 112, its polarization direction changes, and the polarized light will be partially or completely absorbed by the second polarizer 122, and the light will be lost, such that the brightness of light with the oblique viewing angle entering the display panel 20 will be greatly reduced.

In summary, the embodiments of the present disclosure provide a privacy film 10 and a display device 100. The privacy film comprises a liquid crystal dimming cell 11, a first polarizer 12 disposed on one side of the liquid crystal dimming cell 11. The liquid crystal dimming cell 11 comprises a first substrate 111 and a second substrate 113 disposed opposite to each other, and a liquid crystal layer 112 sandwiched between the first substrate 111 and the second substrate 113. The liquid crystal layer 112 comprises a liquid crystal composition, and the liquid crystal composition comprises a plurality of liquid crystal molecules; wherein, the plurality of liquid crystal molecules have the same fixed orientation angle with respect to the first substrate 111, and an orthogonal projection of long axes of the liquid crystal molecules on the first substrate 111 is perpendicular to an absorption axis of the first polarizer 12, such that the brightness of the display screen is not affected when looking up from the front, and the brightness of the display screen is reduced when looking up from the side, therefore a visual anti-peeping effect is achieved.

In the above-mentioned embodiments, the description of each embodiment has its own focus. For parts that are not described in detail in an embodiment, reference may be made to related descriptions of other embodiments.

The above provides a detailed introduction to a privacy film and a display device provided by the embodiments of the present disclosure. Specific examples are used in the discriotion to describe the principles and implementation of the present disclosure. The description of the above embodiments is only used to help understand the technical solution of the present disclosure and its core concept. At the same time, for those of ordinary skill in the art should understand that: they can still modify the technical solutions described in the foregoing embodiments, or equivalently replace some of the technical features; and these modifications or replacements do not deviate the essence of the corresponding technical solutions from the scope of the technical solutions of the embodiments of the present disclosure.

What is claimed is:

1. A privacy film, comprising:
a liquid crystal dimming cell comprising a first substrate and a second substrate that are opposed to each other, and a liquid crystal layer sandwiched between the first substrate and the second substrate, wherein the liquid crystal layer comprises a liquid crystal composition, and the liquid crystal composition comprises a plurality of liquid crystal molecules; and
a first polarizer disposed on one side of the liquid crystal dimming cell;
wherein all of the plurality of liquid crystal molecules have the same fixed orientation angle with respect to the first substrate, and an orthogonal projection of long axes of the liquid crystal molecules on the first substrate is perpendicular to an absorption axis of the first polarizer.

2. The privacy film according to claim 1, wherein the fixed orientation angle of the liquid crystal molecule with respect to the first substrate is 30° to 89°.

3. The privacy film according to claim 2, wherein the fixed orientation angle of the liquid crystal molecule with respect to the first substrate is 30° to 70°.

4. The privacy film according to claim 3, wherein the long axes of the plurality of liquid crystal molecules are arranged obliquely along the same direction, or are distributed symmetrically with respect to a normal direction of the first substrate.

5. The privacy film according to claim 1, wherein the privacy film satisfies the following condition: Δn×d=cos θ×(λ/2+N×λ), where Δn is a difference in birefringence of the liquid crystal molecule, d is a thickness of the liquid crystal layer, θ is an angle formed by an oblique line deviating from the normal direction of the liquid crystal dimming cell and the normal direction of the liquid crystal dimming cell, 0<θ<90°, λ is a wavelength of visible light in vacuum, and N is zero or a positive integer greater than zero.

6. The privacy film according to claim 1, wherein the liquid crystal composition further comprises a polymer, and the polymer accounts for 20% to 70% of a mass percentage of the liquid crystal composition.

7. The privacy film according to claim 6, wherein the liquid crystal composition comprises a polymer network and the liquid crystal molecules, and the long axes of the polymer network and the liquid crystal molecules are aligned in the same direction.

8. A display device comprising a display panel and a privacy film disposed on one side of the display panel, wherein the privacy film comprises:
a liquid crystal dimming cell comprising a first substrate and a second substrate that are opposed to each other, and a liquid crystal layer sandwiched between the first substrate and the second substrate, wherein the liquid crystal layer comprises a liquid crystal composition, and the liquid crystal composition comprises a plurality of liquid crystal molecules; and
a first polarizer disposed on one side of the dimming liquid crystal cell;
wherein all of the plurality of liquid crystal molecules have the same fixed orientation angle with respect to the first substrate, and an orthogonal projection of a long axes of the liquid crystal molecules on the first substrate is perpendicular to an absorption axis of the first polarizer.

9. The display device according to claim 8, wherein the fixed orientation angle of the liquid crystal molecule with respect to the first substrate is 30° to 89°.

10. The display device according to claim 9, wherein the fixed orientation angle of the liquid crystal molecule with respect to the first substrate is 30° to 70°.

11. The display device according to claim 10, wherein the long axes of the plurality of liquid crystal molecules are arranged obliquely along the same direction, or are distributed symmetrically with respect to a normal direction of the first substrate.

12. The privacy film according to claim 8, wherein the privacy film satisfies the following condition: Δn×d=cos θ×(λ/2+N×λ), where Δn is a difference in birefringence of the liquid crystal molecule, d is a thickness of the liquid crystal layer, θ is an angle formed by an oblique line deviating from the normal direction of the liquid crystal dimming cell and the normal direction of the liquid crystal dimming cell, 0<θ<90°, λ is a wavelength of visible light in vacuum, and N is zero or a positive integer greater than zero.

13. The privacy film according to claim 8, wherein the liquid crystal composition further comprises a polymer, and the polymer accounts for 20% to 70% of a mass percentage of the liquid crystal composition.

14. The privacy film according to claim 13, wherein the liquid crystal composition comprises a polymer network and the liquid crystal molecules, and the long axes of the polymer network and the liquid crystal molecules are aligned in the same direction.

15. The display device according to claim 8, wherein the display panel comprises a display panel body and a second polarizer disposed on one side of the display panel body, and the liquid crystal layer is located between the second polarizer and the first polarizer, an absorption axis direction of the first polarizer is parallel to an absorption axis direction of the second polarizer.

16. The display device according to claim 15, wherein the privacy film is disposed on one side of a light emitting surface of the display panel body, and the second polarizer is disposed on one side of the light emitting surface of the display panel body.

17. The display device according to claim 15, wherein the privacy film is disposed on one side facing away from a light emitting surface of the display panel body, and the second polarizer is disposed on one side facing away from the light emitting surface of the display panel body.

18. The display device according to claim 17, wherein the display panel further comprises a third polarizer and a backlight module, the third polarizer is disposed on one side of the light emitting surface of the display panel body, the first polarizer is disposed between the light emitting surface of the backlight module and the liquid crystal layer.

19. The display device according to claim 8, wherein a first alignment film is disposed on one side of the first substrate facing the liquid crystal layer, and a second alignment film is disposed on one side of the second substrate facing the liquid crystal layer.

20. The display device according to claim 8, wherein the privacy film and the display panel are adhered by an adhesive layer.
